(19) United States
(12) Patent Application Publication
(10) Pub. No.: US 2017/0370620 A1
(43) Pub. Date: Dec. 28, 2017

(54) Localized Environment Characterization Device

(71) Applicant: KING ABDULLAH UNIVERSITY OF SCIENCE AND TECHNOLOGY, Thuwal (SA)

(72) Inventors: Hashim Alzain, Thuwal (SA); Tamer Shahin, Thuwal (SA); Ahmed Aljohani, Thuwal (SA); Husam Wafai, Thuwal (SA)

(21) Appl. No.: 15/538,045

(22) PCT Filed: Jan. 12, 2016
(86) PCT No.: PCT/IB2016/050121

§ 371 Date: Jun. 20, 2017

Related U.S. Application Data
(60) Provisional application No. 62/104,773, filed on Jan. 18, 2015.

(51) Int. Cl. F24J 2/52; H02S 30/20; F24J 2/36; F24J 2/54

(52) U.S. Cl. CPC F24J 2/523; F24J 2/54; H02S 30/20; F24J 2/36; F24J 2/5264

(57) ABSTRACT

Various apparatuses and methods are provided for measuring the likely environmental impact of a particular geographic location on power generation properties of potential solar installations at the particular location. In an example embodiment of one such apparatus, a measurement device is provided. The measurement device includes a base portion comprising a base frame element disposed on a plurality of supporting legs, and a top panel comprising a series of connected members and one or more measurement modules whose planar dimensions are defined by the series of connected members. The top panel is connected to the base portion by a joint such that the top panel can rotate about the joint, and a panel support element is configured to fasten the top panel immovably at a desired degree of rotation in relation to the base portion.

### TECHNOLOGICAL FIELD

Example embodiments of the present invention relate generally to the effects of environmental conditions on mechanical devices and, more particularly, to an improved device for the collection of data regarding localized environmental impacts.

### BACKGROUND

The soiling of solar cells has limited the proliferation of solar installations in the Kingdom of Saudi Arabia and the surrounding region due in part to the high impact of soiling on solar performance. Compounding this problem is that the issue of soiling, as it relates to solar power generation, is very specific to the Middle East and North Africa (MENA) region, and is not a typical concern for the majority of the world's solar installations. In this regard, despite the fact that this area of the world has high solar potential and high levels of solar irradiation, the accompanying environmental conditions in the region often produces high soiling rates (largely dust build-up caused by weather events such as high power winds), which can significantly decrease the capacity of solar installations to produce electricity economically.

For instance, soiling parameters; such as gravitational effect, particle size, and wind speed and direction, are often such that varying transmittance of light into the module; leading to small random areas with partial shading from solar radiation, which impacts performance. However, the variation in dust size and composition within the MENA region is highly location-dependent, and thus can vary widely on a localized scale, which makes dust mitigation a challenging and often unpredictable problem. As a result, the market for deploying of solar installations in the MENA region faces several hurdles.

First of all, the lack of government incentives has limited the widespread deployment of large-scale solar farms in comparison with rates of development of other energy sources in the MENA region. In addition, due to the high soiling rates and scarcity of water in regions with high solar potential, wet cleaning methods are typically not economically sustainable. Moreover, the cleaning frequency for solar modules needs to be determined and calculated carefully in advance of installation, because the required frequency of cleaning greatly impacts overhead expense even without considering the cost of desalination and transportation of water to the site. Finally, solar panel degradation is reduced by 1-2% annually due in part to the hot climate in the region.

Due in part to these factors, in many cases the Levelized Cost of Energy (LCOE) of solar farms in the MENA region historically has not been able to compete with conventional forms of electricity generation.

### BRIEF SUMMARY

Despite the harsh weather conditions that impact the MENA region, improvements to the localized quantification of environmental impact on solar cells can still uncover viable sites for solar installations. In this regard, embodiments described herein illustrate measurement devices that can gather and in some embodiments analyze relevant characteristics of a specific location to provide the data necessary to determine ideal locations for weather-sensitive applications (such as solar installations) before requiring the investment of significant resources in a project at the site.

In a first example embodiment, a measurement device is provided. The measurement device includes a base portion and a top panel. The base portion includes a base frame element disposed on a plurality of supporting legs. The top panel includes a series of connected members and one or more measurement modules whose planar dimensions are defined by the series of connected members. In addition, the top panel is connected to the base portion by a joint such that the top panel can rotate about the joint. The measurement device further includes a panel support element configured to fasten the top panel immovably at a desired degree of rotation in relation to the base portion.

In some embodiments, the base frame element includes a plurality of connected members. In some such embodiments, the plurality of connected members comprises four members connected quadrilaterally.

In some embodiments, the measurement device further includes one or more cross members connecting adjacent supporting legs of the base portion. In some such embodiments, the measurement device further includes a shelf disposed on the one or more cross members. The shelf in such embodiments may be wooden. Additionally or alternatively, the shelf may be black to prevent it from reflecting light.

In some embodiments, the plurality of supporting legs of the base portion comprises four supporting legs. In this regard, the measurement device may include a leveling pad disposed at a foot of a first supporting leg and configured to adjust a length of the first supporting leg.

In some embodiments, the measurement device may include a first wheeled element that protrudes laterally from a first supporting leg towards an exterior of the base portion, wherein the first wheeled element provides support for the measurement device in an instance in which the measurement device is tipped in the laterally protruding direction. In some such embodiments, the measurement device may include a second wheeled element that protrudes laterally from a second supporting leg in parallel with the first wheeled element, wherein the first wheeled element and the second wheeled element provide support for the measurement device in an instance in which the measurement device is tipped in the laterally protruding direction. Additionally, the measurement device may include one or more handles attached to the base portion for tipping the measurement device in the laterally protruding direction.

In some embodiments, the top panel includes a plurality of connected exterior members. In this regard, the plurality of connected exterior members may comprise four exterior members connected quadrilaterally. The measurement device may further include one or more cross members, wherein each cross member is connected to two exterior members of the top panel. The measurement device may further include a series of linking members connecting a subset of the one or more cross members and the one or more exterior members of the top panel, wherein the combination of the exterior members of the top panel, the cross members of the top panel, and the linking members define the planar dimensions of each of the one or more measurement modules.

In some embodiments, one of the one or more measurement modules includes a box that is disposed within the measurement module and that defines an interior cavity of the measurement module, wherein the box has an open side facing an upper side of the top panel. In some such embodiments, the measurement device includes an opening in one of the closed sides of the box that exposes the interior cavity of the measurement module to a lower side of the top panel. Additionally or alternatively, the measurement device may include instrumentation disposed within the box. In this regard, the instrumentation disposed within the box may include at least one of a pyranometer, a pyrheliometer, a wind monitor, a thermometer, a humidity sensor, or a datalogger, The one of the one or more measurement module may further include a series of brackets affixed to interior walls of the box to support a measurement cell, and one or more latches affixed to one or more corresponding cross members of the top panel and configured to clamp a measurement cell against the series of brackets. Each latch may in turn include a central rod detachably connected to a cross member of the top panel, a clamping member threaded onto the central rod and having a pincer arm extending over the interior cavity of the measurement module, a cap threaded over the clamping member, and a spring threaded onto the central rode between the clamping member and the cap to cause the pincer arm to apply pressure toward the interior cavity of the measurement module.

The measurement device may include a measurement cell disposed on the series of brackets and affixed to the measurement module by one or more corresponding latches. This measurement cell comprises a solar cell, a glass pane, or a plastic or polycarbonate sheet. This measurement cell may comprise a material having a substantially neutral electrical charge. Additionally or alternatively, this cell may include a coating material disposed on an exterior surface of the measurement cell. In some examples, the coating material may comprise a hydrophobic material, a hydrophilic material, or a TiO₂ material.

In some embodiments, the panel support element may comprise an angle holder and includes at least one fastening element configured to fasten the top panel immovably in relation to the base portion. In this regard, the angle holder may be movably attached to the base portion and affixed to the top panel. Alternatively, the angle holder may be movably attached to the top panel and affixed to the base portion.

In some embodiments, the panel support element may be configured to permit the top panel to rotate from 0 to 90 degrees with respect to the base portion. Additionally or alternatively, the measurement device may further include an angle protractor configured to illustrate an angle of inclination of the top panel with respect to the base portion. In this regard, the angle protractor may be affixed to the top panel. Alternatively, the angle protractor may be affixed to the base portion.

In a second example embodiment, a method is provided for collecting environmental data. The method includes deploying the one or more data collection devices in a target location, wherein each of the one or more data collection devices comprises a measurement device as described above. The method further includes, after a predetermined period of time, retrieving one or more measurement cells from the one or more data collection devices, and measuring surface properties and accumulated dust properties of the retrieved one or more measurement cells.

In a third example embodiment, a method is provided for collecting environmental data. This method includes deploying the one or more data collection devices in a target location wherein each of the one or more data collection device comprises a measurement device as described above, and measuring, by the one or more data collection devices, tilt angle effect and weather data.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings, which are not necessarily drawn to scale, and wherein:

FIG. 1 is a perspective view of a measurement device, in accordance with some example embodiments of the present invention;

FIG. 2 illustrates perspective and cross-sectional views of an example extrusion, in accordance with some example embodiments of the present invention;

FIG. 3 illustrates a side view of a measurement device, in accordance with some example embodiments of the present invention;

FIG. 4 illustrates a closer perspective view of a portion of a measurement device at which a base portion connects to a top panel, in accordance with some example embodiments of the present invention;

FIG. 5 illustrates a perspective view of an example leveling pad, in accordance with some example embodiments of the present invention;

FIG. 6 illustrates a perspective view of an example T handle, in accordance with some example embodiments of the present invention;

FIG. 7 illustrates a perspective view of an example box that is disposed within a measurement module, in accordance with some example embodiments of the present invention;

FIG. 8 illustrates a top view of a measurement device, in accordance with some example embodiments of the present invention;

FIGS. 9 and 10 illustrate perspective views of a top panel of a measurement device, in accordance with some example embodiments of the present invention;

FIG. 11 illustrates a perspective view of a measurement module, in accordance with some example embodiments of the present invention;

FIG. 12 illustrates a perspective view of an example latch, in accordance with some example embodiments of the present invention; and

FIG. 13 illustrates a flow chart including example operations for determining the environmental impacts posed to weather-sensitive applications, in accordance with some example embodiments of the present invention.

### DETAILED DESCRIPTION

Some embodiments of the present invention will now be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As described above, embodiments of the present invention enable the determination of environmental impacts posed to weather-sensitive applications (such as solar installations) by specific geographic locations before requiring the investment of significant resources in projects at those geographic locations. For instance, various embodiments provide the ability to evaluate the effect of an inclination angle on solar cell soiling rates, the effects of different solar cell coatings on solar cell soiling rates, the required frequency of cleaning of solar cells, and the overall effect of soiling on solar performance yield. Similarly, embodiments having multiple measurement cells on a single measuring device can evaluate the efficacy of different solar cell coatings at the same time. Moreover, in some embodiments, multiple measurement devices can be deployed at a single site to measure a wider variety of these and other variables.

In other words, measurement devices described herein may be used as energy audit devices for solar applications and may enable determination of the optimum technologies to install based on scientific findings. More generally, embodiments described herein may be used to perform environmental audits in advance of the deployment of any type of weather-sensitive installation.

### Structural Aspects of Example Measurement Devices

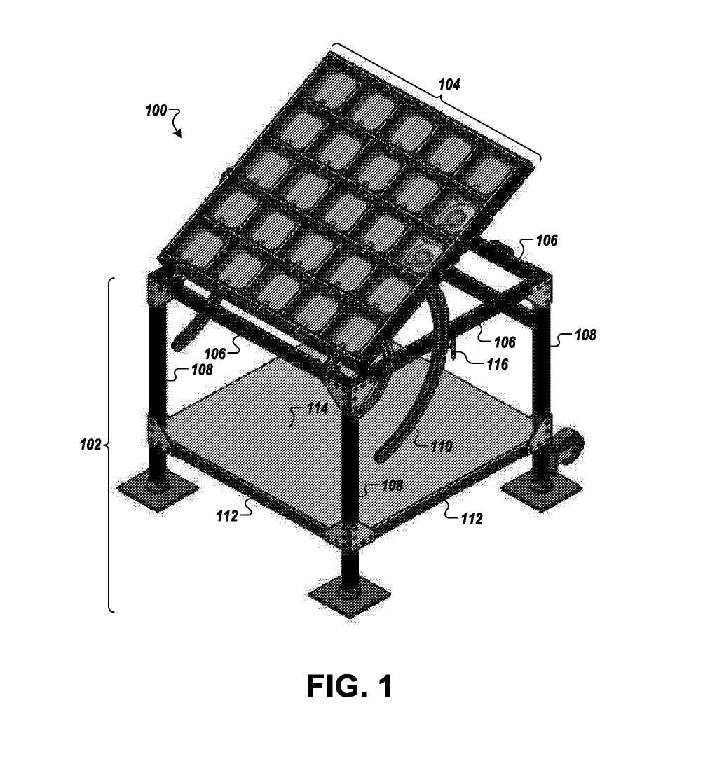

Specific structural arrangements of example measurement devices will now be presented with reference to FIGS. 1 through 12. It should be understood that various modifications to these structural arrangements can be made without departing from the spirit or scope of the present invention. For instance, optional elements described in connection with one embodiment are intended to also be usable with other embodiments to the extent that such combinations do not conflict with the explicit descriptions and illustrations provided herein and in the Figures.

Turning now to FIG. 1, an illustration of an example measurement device 100 is provided. As shown in FIG. 1, measurement device 100 includes a base portion 102 and a top panel 104. The base portion 102 comprises a base frame element 106 comprising a plurality of connected members disposed on a plurality of supporting legs 108. The top panel 104 includes a series of connected members and one or more measurement modules whose planar dimensions are defined by the series of connected members. The top panel 104, which in FIG. 1 is tilted with respect to the base portion, is further connected to the base portion 102 by a joint such that the top panel 104 can rotate about the joint. To suspend top panel 104 at an angle, as shown in FIG. 1, the measurement device 100 includes a panel support element 110 configured to fasten (via T handle 116) the top panel 104 immovably at a desired degree of rotation in relation to the base portion 102. The joint and the panel support element 110 are described in greater detail below.

In the example measurement device 100 shown in FIG. 1, the base frame element 106 comprises four members connected quadrilaterally (i.e., forming a four-sided structure), and four supporting legs 108 (note that while FIG. 1 only shows three legs, a fourth supporting leg 108 is hidden behind the top panel 104 in the perspective view shown in FIG. 1) connected to the base frame element 106. These members and supporting legs 108 may be connected using any suitable means, and in the example measurement device 100 shown in FIG. 1, these component elements are connected together using a series of brackets.

It should be understood that while the base frame element 106 in FIG. 1 comprises a quadrilateral structure and that this example includes four supporting legs 108, these specific properties of measurement device 100 are not mandatory. The base frame element 106 of other embodiments may contain more or fewer sides, and the plurality of support legs 108 in other embodiments may include more or fewer supporting legs 108. As a result, the base frame element 106 need not be quadrilateral. For instance, in embodiments in which the base frame element 106 consists of three connected members, the base frame element 106 may form a triangular structure.

As further illustrated in FIG. 1, the base portion may additionally include one or more cross members 112, which connect adjacent supporting legs 108 of the base portion 102. While only two cross members 112 are visible in FIG. 1, the example measurement device 100 also includes two other cross members 112 that are hidden in the perspective view provided in FIG. 1. These cross members 112 provide added strength and stability to the plurality of supporting legs 108.

Resting atop (and in some embodiment permanently affixed to) the cross members 112 is a shelf 114, which may in turn support measurement equipment (not shown in FIG. 1) in some embodiments. The shelf may be made of wood, although this is not a requirement and other alternative materials may be used. In an instance in which shelf 114 is made of wood, however, the wood may further be varnished to increase the ability of the shelf 114 to withstand the environmental conditions in which the measurement device 100 will be located. Regardless of the material of shelf 114, however, the shelf 114 should be painted or otherwise made black to avoid reflecting light towards the top panel 104. In an instance in which the shelf 114 is not black, reflected light may affect the accuracy of the environmental measurements captured by the measurement modules included in the top panel 104.

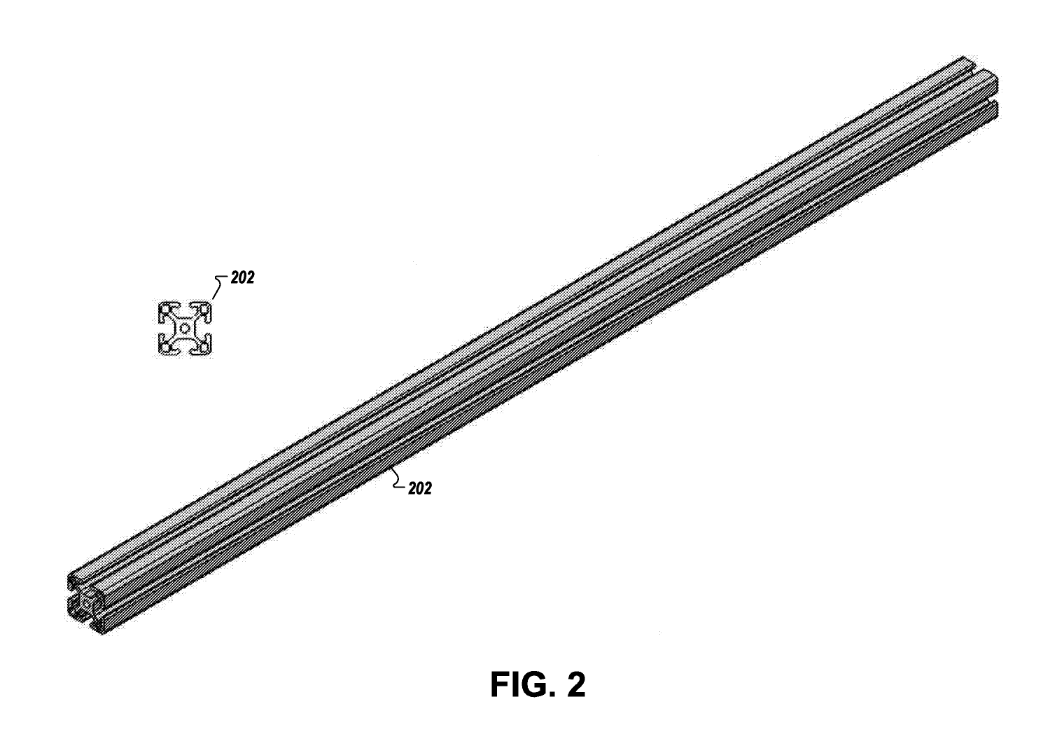

Turning now to FIG. 2, perspective and cross-sectional views of an example extrusion 202 are shown. Extrusion 202, shown in FIG. 2, comprises an aluminum extrusion, and is representative of the component members assembled to form measurement device 100. In this regard, aluminum extrusions are used as the component elements of the measurement device 100 in many embodiments due to its light weight, low cost, and ease of assembly when compared to some alternative components. However, it should be understood that other material and/or types of connective members may be used to assemble the measurement device in other embodiments.

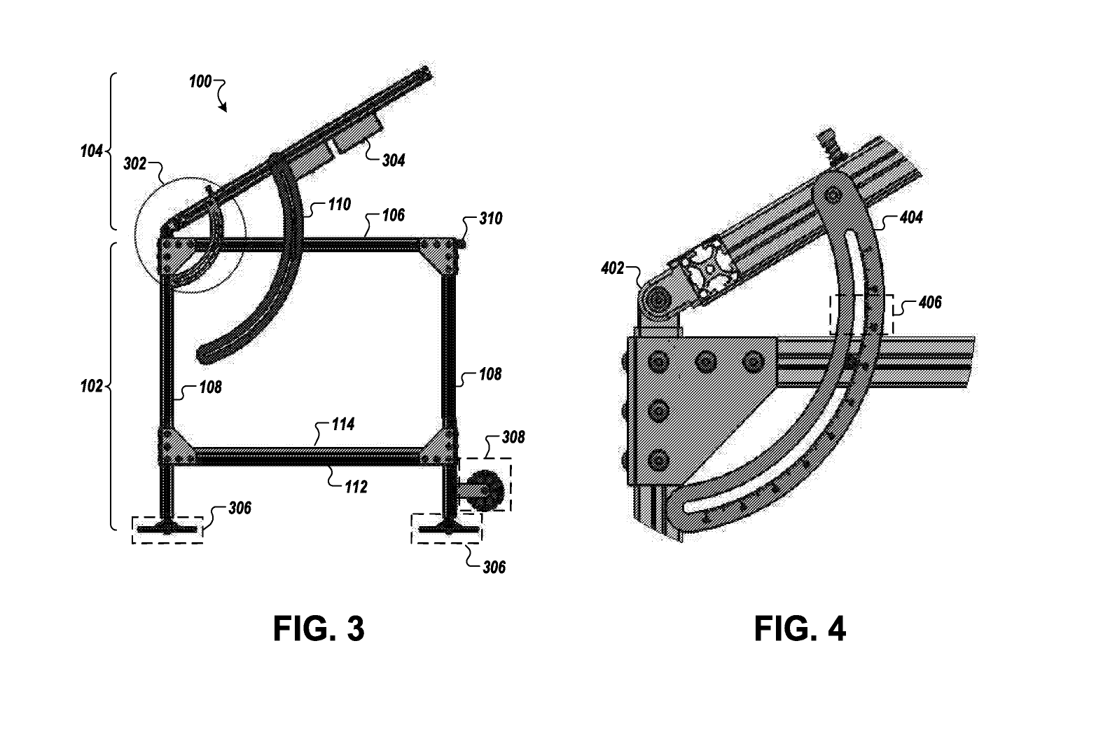

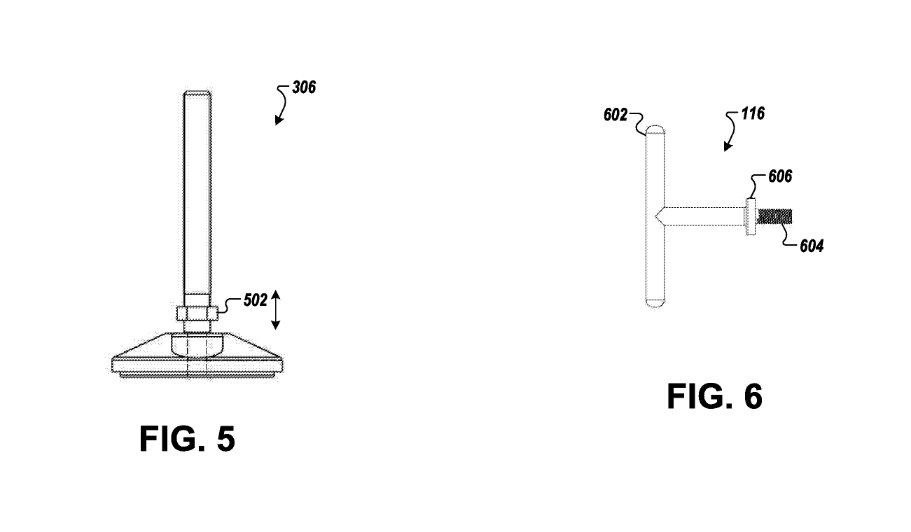

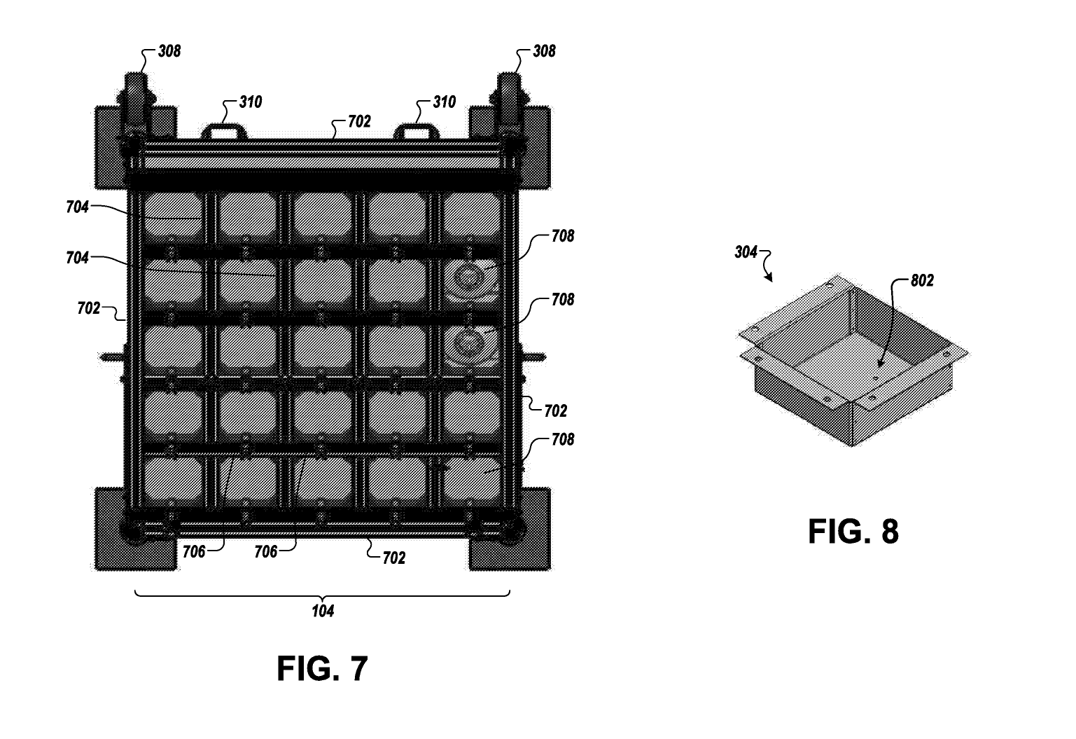

Turning now to FIG. 3, a side view of measurement device 100 is illustrated. As more clearly shown in FIG. 3, the measurement device 100 further includes an angle protractor 302, which is described in greater detail in connection with FIG. 4 below. As also shown in FIG. 3, each measurement module of the measurement device 100 may include a box 304 defining an interior cavity of a respective measurement module. This box is described in greater detail below in connection with FIG. 7. Moreover, each supporting leg 108 of the measurement device 100 may further include a leveling pad 306 disposed at its foot that is configured to adjust a length of the supporting leg 108. An expanded view of an example leveling pad 306 is illustrated in FIG. 5, in which adjustment element 502 can be manipulated (e.g., by screwing it clockwise or counterclockwise) to increase or decrease the length of the leveling pad 306.

As shown in FIG. 3, the measurement device 100 may further include a wheeled element 308 that protrudes laterally from a supporting leg 108 towards an exterior of the base portion 102. This wheeled element 308 provides support for the measurement device 100 in an instance in which the measurement device 100 is tipped in the laterally protruding direction. Furthermore, FIG. 8 further shows that the example measurement device 100 in fact also includes a second wheeled element 308 that protrudes laterally from another supporting leg 108 in parallel with the first wheeled element 308, wherein the first wheeled element 308 and the second wheeled element 308 provide support for the measurement device 100 in an instance in which the measurement device 100 is tipped in the laterally protruding direction. Of course, it should be understood that there may be one wheeled element, two wheeled elements, or additional wheeled elements in various embodiments contemplated herein, and the number of wheeled elements may be impacted by the number and arrangement of supporting legs 108 included in a particular embodiment. In addition, FIG. 3 further illustrates a handle 310, which is attached to the base portion 102 (and more specifically to the base framed element 106) for tipping the measurement device in the laterally protruding direction (and FIG. 8 illustrates that a second handle 310 may also be included, as shown from a top view). It should, however, be understood that the handle(s) 310 may attach anywhere on the base portion 102 as long as the point of attachment enables a user to tilt the measurement device 100 in the laterally protruding direction.

Finally, the side view of measurement device 100 shown in FIG. 3 provides a clearer view of the panel support element 110. In some embodiments, this panel support element comprises an angle holder and includes at least one fastening element (e.g., T handle 116) configured to fasten the top panel immovably in relation to the base portion. FIG. 6 illustrates an enlarged perspective view of an example T handle 116. As shown in FIG. 6, the T handle includes a handle portion 602 which can be turned clockwise or counterclockwise to engage or disengage the threaded portion 604 of the T handle into the panel support element 110 and a portion of the measurement device 100 (such as, for instance, a connecting member of the base frame element 106). In this regard, the angle holder may be movably attached to the base portion using the T handle 116 and permanently affixed to the top panel. Alternatively, the angle holder may be movably attached to the top panel using the T handle 116 and permanently affixed to the base portion. Either way, when the threaded portion of the T handle 116 is sufficiently engaged with the panel support element 110 and the measurement device 100, the pressure applied by a clamping portion 606 of the T handle 116 to the panel support element and the measurement device 100 prevent movement between the base portion 102 and top frame 104. In this regard, the panel support element 110 is configured to permit the top panel 104 to rotate from 0 to 90 degrees with respect to the base portion 102. It should, of course, be understood that while a single panel support element 110 is described here, the measurement device 100 uses two panel support elements 110, and in various embodiments yet further panel support elements 110 may be optionally considered depending on the physical properties and relative positions of the various elements of the measurement device 110.

Turning now to FIG. 4, a closer perspective view illustrates the portion of the measurement device 100 at which the base portion 102 connects to the top panel 104. As shown in FIG. 4, the joint referenced in FIG. 1 (which rotatably connects the top panel 104 to base portion 102) may in some embodiments connect the top panel 104 to the base frame element 106. This joint may in some embodiments comprise a plurality of joints disposed along the length of one connected member of the base frame element 106. The joint illustrated in measurement device 100 comprises a hinged joint, although other types of mechanical joints may be used to rotatably connect top panel 104 to base portion 102.

FIG. 4 further illustrates an angle protractor 404 of measurement device 100, in accordance with some example embodiments of the present invention. Like the angle holder described above, angle protractor 404 may be affixed to the top panel 104 or may be affixed to the base portion 102. Unlike the angle holder described above, however, angle protractor 404 is not affixed to both elements, and is not used to provide physical support to the top panel 104. Regardless of where, specifically, the angle protractor 404 is affixed, as shown in element 406 of FIG. 4, angle protractor 404 is instead configured to illustrate an angle of inclination of the top panel 104 with respect to the base portion 102 (e.g., by displaying a series of ruled markings that illustrate different angles of inclination). It should be understood, of course, that the features of angle protractor 404 that enable illustration of the angle of inclination of the top panel 104 may be utilized by the panel support element 110 (e.g., in an instance in which the panel support element 110 is an angle holder, it may include the ruled markings described with respect to the angle protractor). In such embodiments, inclusion of a separate angle protractor 404 may not be necessary.

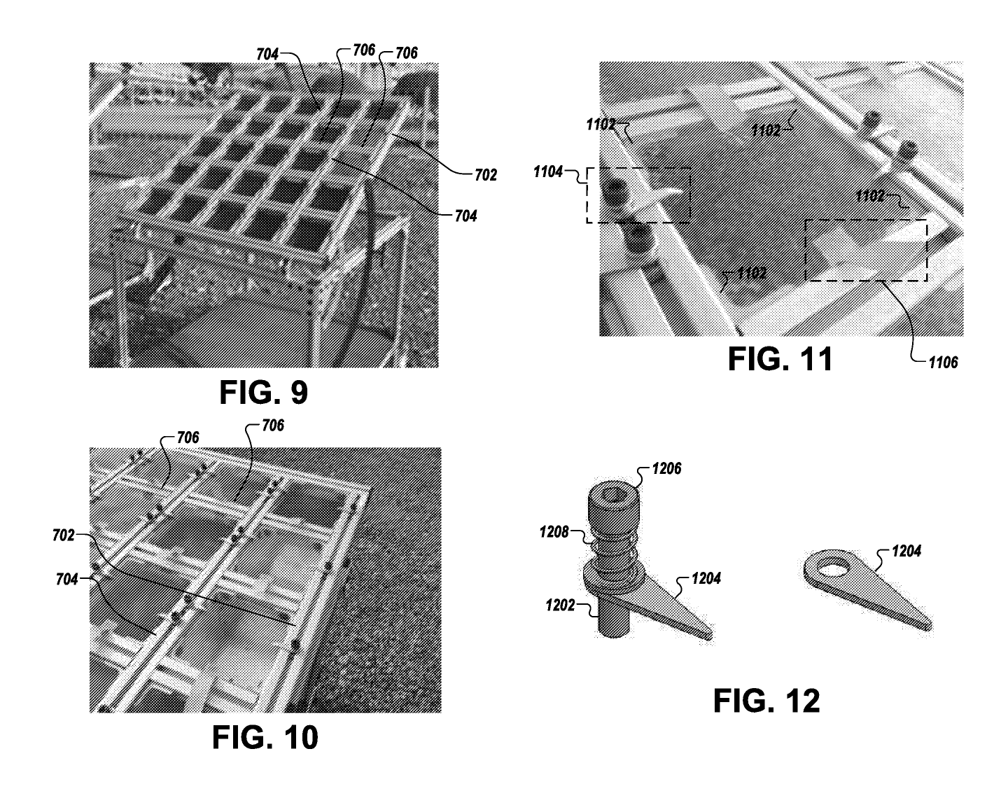

Turning now to FIG. 7, which illustrates a top view of the example measurement device 100, the top panel 104 will hereafter be described in greater detail. As shown in FIG. 7, the top panel 104 comprises a series of connected members, like the base frame element 106 beneath it. In this regard, the top panel 104 includes a plurality of exterior connected members 702, which in some embodiments, may comprise four exterior members 702 connected quadrilaterally. Similarly, the top panel 104 may further include one or more cross members 704, wherein each cross member 704 connects two exterior members 702 of the top panel 104. Furthermore, the top panel 104 may also include a series of linking members 706 connecting a subset of the one or more cross members 704 and the one or more exterior members 702 of the top panel 104. As shown in FIG. 7 (and as shown from different perspectives in FIGS. 9 and 10), the combination of the exterior members 702, the cross members 704, and the linking members 706 define the planar dimensions of each of the one or more measurement modules 708. An element of an example measurement module 708 is further illustrated in FIG. 8, and will be described in greater detail below.

Turning now to FIG. 8, a box 304 is illustrated that is disposed within a measurement module 708 and that defines an interior cavity of the measurement module 708. The box 304 has an open side facing the upper side of the top panel 104. Put another way, when the top panel 104 has an angle of inclination of 0 degrees (e.g., when it lies flat above the base portion 102), the open side of box 304 faces vertically away from the measurement device 100. As further illustrated in FIG. 8, the box 304 in some measurement modules 708 may include a separate opening 802 in one of the closed sides of the box. This opening 802 provides an outlet from the interior cavity of the measurement module to a lower side of the top panel.

In this regard, instrumentation may be disposed within the box 304 located in a measurement module 708. The instrumentation may, in some embodiments, include at least one of a pyranometer, a pyrheliometer, a wind monitor, a thermometer, a humidity sensor, or a datalogger, although other sensor devices may alternatively be used depending on the particular needs of the geographic location where the measurement device 100 is intended to be placed, as detailed in several example embodiments discussed below. The instrumentation disposed in box 304 may in turn have connected cabling that runs through the opening 802 to other measurement equipment disposed on the shelf 114 (such as a power source). Similarly, larger pieces of equipment may be disposed on shelf 114 and have smaller attachments (e.g., sensor probes or the like) that are located within box 304 for measurement and that are connected to the larger pieces of equipment via cabling that runs through the opening 802.

Turning now to FIG. 11, a perspective view of a measurement module 708 is illustrated. As shown in FIG. 11, each measurement module 708 may include a series of brackets affixed to interior walls of the corresponding box 304 to support a measurement cell (e.g., a solar cell, a glass pane, a plastic or polycarbonate sheet, or the like). In this regard, the brackets may in some embodiments be affixed within the interior walls of each box 304 at a height that results in any added measurement cell protruding slightly above the upper surface of the top panel 104 (rendering it easier to remove the measurement cells without touching their top or bottom surfaces). To this end, in some embodiments, a measurement cell may be disposed on the series of brackets and affixed to the measurement module by one or more corresponding latches 1104. Each latch 1104 may be affixed to one or more corresponding cross members 704 of the top panel 104 and configured to clamp a measurement cell against the series of brackets 1102 in a corresponding measurement module 708. The latch mechanism is described in greater detail in conjunction with FIG. 12. Additionally or alternatively, one or more of the measurement cells may include a fabric tab affixed that can be used to remove the measurement cell from the measurement module.

Turning now to FIG. 12, a perspective view of an example latch 1104 is illustrated in greater detail. The latch 1104 may in some embodiments include a central rod 1202 detachably connected to a cross member 704 of the top panel 104. A clamping member 1204 may be threaded onto the central rod 1202 and may be include a pincer arm that extends over the interior cavity of the measurement module 708. This pincer arm may taper to a downwardly angled point to minimize the surface area of contact with a measurement cell. A cap 1206 may be threaded over the clamping member, and a spring 1208 may be threaded onto the central rode 1202 between the clamping member 1204 and the cap 1208 to cause the pincer arm to apply pressure toward the interior cavity of the measurement module 708 (and, when a measurement cell has been placed in the measurement module, to constrain movement of the measurement cell).

As noted above, a measurement cell may be disposed on the series of brackets and clamped in place within the measurement module by one or more corresponding latches 1104. The measurement cell may be made of a material having a substantially neutral electrical charge (a charged material may attract dust at a modified rate, and thus measurements may be skewed if the measurement cell has a significant electric charge). Furthermore, the measurement cell may have a coating material disposed on its exterior surface, and this coating material may comprises a hydrophobic material, a hydrophilic material, or, for instance, a TiO₂ material, all of which demonstrate different levels of efficiency in different weather conditions.

### Equipment Configurations of Example Measurement Devices

Having provided an outline of the various elements of a measurement device 100, it should be understood that various embodiments described herein may include various combinations of measurement equipment. In this regard, it should be understood that there are a set of four categories of measurement parameters that may be measured to draw meaningful conclusions regarding the viability of a weather-sensitive installation such as a solar installation. Different configurations of measurement equipment that may be added to example measurement device 100 are described below and are based on these categories of parameters.

The first category of parameters regards the surface properties of a measurement cell. These parameters include hardness, smoothness, hydrophobicity, surface energy/contact angle, electrical properties (e.g., polarity), and refractive index. A sample of a measurement cell having prolonged exposure to a particular environment can be analyzed to identify each of these properties (although the above mentioned measurements should be taken for fresh samples to establish baselines before deployment in a measurement device 100 to maximize the accuracy of data collected regarding these surface parameters. Two additional surface properties: the light transmission of soiled samples (e.g., light intensity and spectrum shifts); and the effect of soiling on solar angle of incidence, can be measured without necessarily requiring a baseline measurement.

A second category of parameters regards the accumulated dust properties of a measurement cell. With regard to these properties, the measurement cell samples can be analyzed to identify the quantity of dust per unit area, dust layering information, dust spatial uniformity (e.g., gradient, edge effect, or the like), a dust particle distribution profile (number of particles vs. size), chemical composition, and electrical properties.

Data can be collected using a measurement device 100 for lab analysis regarding the above two categories. For the second two categories of parameters, however, embodiments described herein contemplate analyzing data either in a lab or in the field by the measurement device 100.

The first of these categories can be broadly categorized as the tilt angle effect. In this regard, the effect of module tilt angle on dust accumulation rate can be calculated via post-processing the following output data for different tilt angles, soiling periods, and different coatings: irradiation penetrating glass samples vs. reference irradiation, where irradiation penetrating glass can be measured in two ways (using permanent sensors with automatic data collection or by manual measurement using a portable Pyranometer); and output of photovoltaic cells vs. reference irradiation. With regard to the latter category, the photovoltaic output can be measured either by using a maximum power point (MPP) tracker to measure the real output of cell (e.g., measuring the short circuit current and open circuit voltage and then interpolating the two to get the real output of the cell) or by a comparison of dust quantity vs. tilt angle, and possibly different layering behavior vs. tilt angle.

The second of these categories that can be analyzed in the field can be broadly characterized as weather data. This category includes: reference horizontal irradiation; reference tilted irradiation; direct normal irradiance (DNI) and diffused irradiation measurements; ambient temperature; photovoltaic cell temperature; humidity; and wind direction and speed.

With respect to these second categories of parameters, not only can the measurement device 100 capture the data required to perform the analysis, this analysis can be performed autonomously in the field, with the addition of corresponding computing equipment and appropriate software.

Given these categories of measurement parameters, the following configurations of the measurement device 100 are contemplated to provide a range of capabilities, from barebones data harvesting capabilities to very robust data collection and analysis capabilities.

A barebones implementation of the measurement device 100 may not include significant amount of measurement equipment, and may be provided in special locations where minimal support is needed. This implementation is ideal for when access to the measurement device 100 will only be needed periodically to do measurements and/or collect samples. For this purpose, only the measurement device skeleton described above and dust collection boxes (located in one or more of the measurement modules 708), along with basic tools (e.g., cleaning tools, sample holders, data collection templates etc.) will be required.

For a mid-level dust mitigation station that can be deployed in locations that need minimal observation and measurement (O&M) services, the measurement device 100 may include a second-class pyranometer or two pyrgeometers, an on-board computer/data logger for continuous logging of data, and the instrumentation from the first embodiment above.

For a high grade research-level station to be used in areas where daily O&M services may be provided (e.g., at a university or collaborator site), the measurement device 100 may include a first class reference pyranometer to replace irradiation sensors, a plurality of reference cells (at least two), a basic weather station, and the other resources as the second embodiment above.

Finally, in special locations where collaborators require special measurements, the measurement device 100 may need to add a pyrheliometer (with an accompanying tracker), an aerosol measurement device, and a dust detection system (DDS).

### Operations for Collecting Environmental Data Using Example Measurement Devices

Having described an example measurement device 100 above, the following section describes particular operations that may be performed using the measurement device 100. As an initial matter and as indicated above, example measurement devices contemplated herein are highly configurable and allow an operator to add or remove measurement equipment as needed. In this regard, measurement equipment may be added to one or more of the measurement modules 708 or may be added to a shelf 114 with a corresponding probe placed within one or more measurement modules 708 to measure properties of corresponding measurement cells and/or the environmental characteristics at a particular height and/or angular tilt. As yet another alternative, measurement equipment or may simply be added to the shelf 114 to collect measurements directly and not through a measurement module or measurement cell.

If a site is under consideration for a weather-sensitive deployment (e.g., a solar installation), one or more measurement devices 100 can be equipped with measurement equipment and deployed to the site without the need for significant additional investment and without incurring significant initial expense. After a sufficient period of time had passed, measurement cells on the measurement devices can be removed and transported to a lab for analysis. In some embodiments, the data collection and analysis may even occur in the field. In either case, the data collected using the measurement cells of the measurement devices 100 can thus quantify the economic viability of a solar installation at the site that is under consideration.

Moreover, solar installations may in have different configurations to function optimally in different environmental conditions. For example, TiO₂ coating is suitable for coastal regions that experience significant layers of organics on solar module surfaces, but would not perform optimally in arid dry inland regions.

As a result, in one example a measurement device as described herein can be deployed including a number of different measurement cells (e.g., 25, as illustrated in measurement device 100 shown in FIGS. 1-12) that can be used to collect data and identify the optimum coating material to implement for a localized area that maximizes the efficiency of solar power generation.

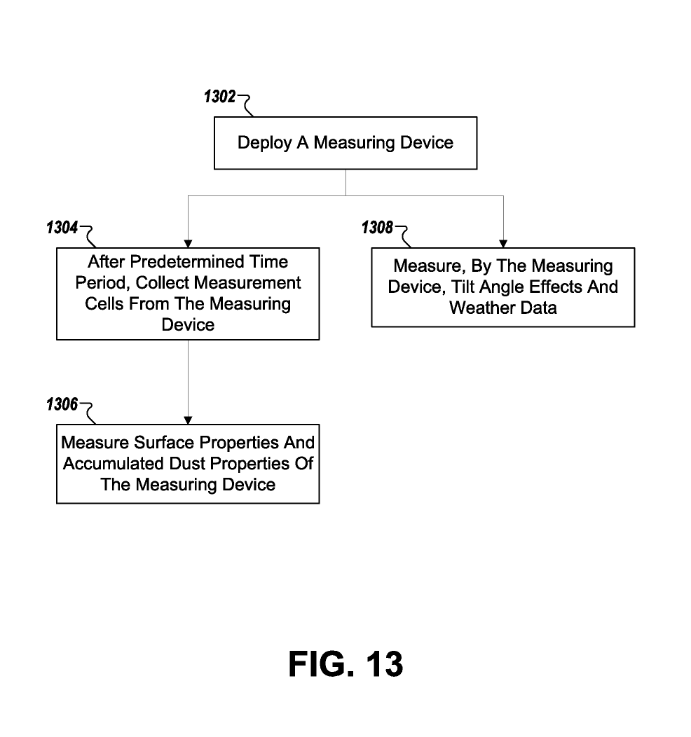

FIG. 13 illustrates a flowchart containing a series of operations performed by example embodiments described herein for measuring the likely environmental impact of a particular geographic location on power generation properties of potential solar installations at the particular location. In operation 1302, one or more measurement devices may be deployed in a target location. After a predetermined period of time, in operation 1304, one or more measurement cells may be retrieved from the one or more data collection devices. Subsequently, in operation 1306, properties of these measurement cells may be analyzed. For instance, lab analysis may in many cases be required for measuring surface properties and accumulated dust properties of the cells to estimate the soiling rate of the deployment site. It should be understood, of course, that while data can be collected in the field by measuring devices that are described herein, in some embodiments, some data collected by the measuring device can also be analyzed in the field. To this end, in operation 1308, the measurement device itself may measure some aspects of the collected data, such as for instance the tilt angle effect and weather data.

Various embodiments of the above-described measurement device thus enable the determination of environmental impacts posed to weather-sensitive applications (such as solar installations) by specific geographic locations. Importantly, the present invention enables these impacts to be understood before requiring the investment of significant resources in projects at those geographic locations. Various embodiments provide additional benefits as well.

For instance, various example embodiments illustrate the flexibility and modularity of the measurement device, thus illustrating how the device commends itself to a variety of price points and data collection processes. In this regard, it is possible to both change the size and number of measurement cells used by example measurement cells, and also alter the measurement equipment used by the measurement device. Additionally, given the relatively small size of the measurement device, it is highly mobile. Furthermore, the measurement device is adjustable to accommodate different tilt-angles at specific sites ranging from horizontal (0°) to vertical (90°), which is not possible with other types of designs. Moreover, without instrumentation, the measurement device carries a relatively low cost and would thus be useful for a wider variety of applications.

Some other benefits include the ability to measure the efficacy of a large number of 25 different cell coatings simultaneously (by including different coatings with measurement cells in different measurement modules). Similarly, it is possible to add remote monitoring and communication capabilities for easier access to the measurement tools and equipment readings. In addition, because the measurement cells is easily replaceable, the measurement device enables the use of a variety of measurement cells, such as mirrors, glass, reference solar cells, plastic, or the like, and thus the measurement device can suit a variety of different needs and requirements.

More practically, the results derived from parameter measurements and post-calculations apply to solar photovoltaic, concentrated photovoltaic, and concentrated solar power (CSP) technologies. Finally, the measurement device described herein provides the ability to quantify the composition and characteristics of site-specific soiling using these measurement devices, which enables project owners to justify required investments/funding that would ensure positive returns on investment.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A measurement device comprising:
a base portion comprising a base frame element disposed on a plurality of supporting legs;
a top panel comprising a series of connected members and one or more measurement modules whose planar dimensions are defined by the series of connected members, wherein the top panel is connected to the base portion by a joint such that the top panel can rotate about the joint; and
a panel support element configured to fasten the top panel immovably at a desired degree of rotation in relation to the base portion.

2. The measurement device of claim 1, wherein the base frame element includes four members connected quadrilaterally.

3. (canceled)

4. The measurement device of claim 1, further comprising:
one or more cross members connecting adjacent supporting legs of the base portion; and
a shelf disposed on the one or more cross members.

5-8. (canceled)

9. The measurement device of claim 1, further comprising a leveling pad disposed at a foot of a first supporting leg and configured to adjust a length of the first supporting leg.

10. The measurement device of claim 1, further comprising:
a first wheeled element that protrudes laterally from a first supporting leg towards an exterior of the base portion, wherein the first wheeled element provides support for the measurement device in an instance in which the measurement device is tipped in the laterally protruding direction; and
one or more handles attached to the base portion for tipping the measurement device in the laterally protruding direction.

11. The measurement device of claim 10, further comprising a second wheeled element that protrudes laterally from a second supporting leg in parallel with the first wheeled element, wherein the first wheeled element and the second wheeled element provide support for the measurement device in an instance in which the measurement device is tipped in the laterally protruding direction.

12. (canceled)

13. The measurement device of claim 1, wherein the top panel includes four exterior members connected quadrilaterally.

14. (canceled)

15. The measurement device of claim 13, further comprising:
one or more cross members, wherein each cross member is connected to two exterior members of the top panel; and
a series of linking members connecting a subset of the one or more cross members and the one or more exterior members of the top panel,
wherein the combination of the exterior members of the top panel, the one or more cross members of the top panel, and the linking members define the planar dimensions of each of the one or more measurement modules.

16. (canceled)

17. The measurement device of claim 1, wherein one of the one or more measurement modules includes:
a box that is disposed within the measurement module and that defines an interior cavity of the measurement module, wherein the box has an open side facing an upper side of the top panel.

18. The measurement device of claim 17, further comprising an opening in one of the closed sides of the box that exposes the interior cavity of the measurement module to a lower side of the top panel.

19. The measurement device of claim 17, further including instrumentation disposed within the box, wherein the instrumentation disposed within the box includes at least one of a pyranometer, a pyrheliometer, a wind monitor, a thermometer, a humidity sensor, or a datalogger.

20. (canceled)

21. The measurement device of claim 17, wherein the one of the one or more measurement module further includes:
a series of brackets affixed to interior walls of the box to support a measurement cell; and
one or more latches affixed to one or more corresponding cross members of the top panel and configured to clamp a measurement cell against the series of brackets.

22. The measurement device of claim 21, wherein each latch includes:
a central rod detachably connected to a cross member of the top panel;
a clamping member threaded onto the central rod and having a pincer arm extending over the interior cavity of the measurement module;
a cap threaded over the clamping member; and
a spring threaded onto the central rode between the clamping member and the cap to cause the pincer arm to apply pressure toward the interior cavity of the measurement module.

23. The measurement device of claim 21, further comprising a measurement cell disposed on the series of brackets and affixed to the measurement module by one or more corresponding latches, wherein the measurement cell comprises a solar cell, a glass pane, or a plastic or polycarbonate sheet, and wherein the measurement cell comprises a material having a substantially neutral electrical charge.

24-25. (canceled)

26. The measurement device of claim 23, further comprising a coating material disposed on an exterior surface of the measurement cell, the coating comprising a hydrophobic material, a hydrophilic material, or a TiO₂ material.

27. (canceled)

28. The measurement device of claim 1, wherein the panel support element comprises an angle holder and includes at least one fastening element configured to fasten the top panel immovably in relation to the base portion.

29-30. (canceled)

31. The measurement device of claim 1, wherein the panel support element is configured to permit the top panel to rotate from 0 to 90 degrees with respect to the base portion.

32. The measurement device of claim 1, further comprising an angle protractor configured to illustrate an angle of inclination of the top panel with respect to the base portion.

33-34. (canceled)

35. A method for collecting environmental data, the method comprising:
deploying the one or more data collection devices in a target location, wherein each of one or more data collection device comprises a measurement device according to claim 1;
after a predetermined period of time, retrieving one or more measurement cells from the one or more data collection devices; and
measuring surface properties and accumulated dust properties of the retrieved one or more measurement cells.

36. A method for collecting environmental data, the method comprising:
deploying one or more data collection devices in a target location wherein each of the one or more data collection device comprises a measurement device according to claim 1; and
measuring, by the one or more data collection devices, tilt angle effect and weather data.
